(19) United States
(12) Patent Application Publication
(10) Pub. No.: US 2002/0015843 A1
(43) Pub. Date: Feb. 7, 2002

(54) Garage door protector

(76) Inventor: Lorenzo Brown, Centerville, OH (US)

Correspondence Address: LORENZO BROWN, 473 MAPLE SPRINGS DRIVE, CENTERVILLE, OH, 45458, US

(21) Appl. No.: 09/903,154

(22) Filed: Jul. 11, 2001

Related U.S. Application Data
(60) Provisional application No. 60/218,297, filed on Jul. 14, 2000.

(51) Int. Cl. B32B 7/12

(52) U.S. Cl. 428/343

(57) ABSTRACT

a device or apparatus that when attached to a garage door will protect its surface from damage. The primary use is for the protection of the garage door's outer surface from dents caused when the game of basketball is being played in a driveway or on other surfaces near a garage door. The Garage Door Protector is close in dimensions to a garage door's size. The garage door Protector is made of lightweight materials or substances so that it can be easily placed against a garage's door. The outer shell of a layered protector is waterproof or water resistant due to its outside use. A form of padded material, air, air pillows, or any impact absorbing or resistant substance, is used to fill the interior of the protector. The backside of the protector is also waterproof or resistant and also provides one of the possible surfaces for attaching the protector to a garage door. Where a single sheet, or more are used, the cushion affect must be maintained to protect the garage door and to resist or absorb impact. The protector provides a padded cushion affect to protect a garages door or doors outer surface from the damage usually caused by sports players such as basketball players, when they or the ball, hits the garage door. The protector can be attached to the garage door by several different methods, such as hook and loop, magnetic strips, hooks, etc, depending the material used to make the garage door. Most doors are made of steel, wood, or a composite. The garage door protector's total thickness can be thin enough so that the garage door may be raised with the protector attached. This will avoid having to take it down after each game

### CROSS-REFERENCE TO RELATED APPLICATIONS

This application is entitled to the benefits of Provisional Patent Application Serial No. jc474 U.S. PTO 60/218297 filed Jul. 14, 2000

### STATEMENT REGARDING FEDERALLY SPONSORED R&D

Not applicable

### REFERENCE TO MICROFICHE

Not applicable

### BACKGROUND

1. Field of Invention

This invention minimizes or prevents damage to the exterior of a garage door while playing sports games in driveways

2. Prior Art

Not applicable

This invention solves the general problem of dents and other damage to the exterior of a garage door, when sports games such as basketball, are played in residential driveways. The damage is often caused by the basketball and/or the players, forcefully hitting the door.

### SUMMARY

A garage door protector is comprised of a single or multiple layers of protective materials or substances, which form a padded thickness. When applied or attached to the exterior of a garage door, it will help minimize or prevent damage while playing sports games.

### OBJECTS AND ADVANTAGES

Accordingly, several objects of my invention are:

(a) Protects garage doors from damage and thus costly repairs or replacement

(b) Allows sports players to take advantage of the full length of driveways

(c) Helps to prevent injuries by cushioning the garage doors exterior surface

(d) Helps to prevent injuries by allowing garage doors to be closed during sports games versus of open; allowing player to accidentally fall into garage interiors

(e) Support sport players desire to have basketball goals mounted above the garage door to extend shot range of basketball players

Other objects of my invention are:

(a) Can provide an attractive cover for previously damaged garage doors

(b) Can help speed up sports games by preventing balls from going out of bounds into a garage with the door kept open to prevent damage if closed without the protection of this invention There are no known prior inventions, so the advantages of this invention are similar to the objects. Most standard garage doors are made of steel or wood and their exterior surfaces are not designed to take the abuse of balls or players banging against them

### DRAWING FIQURES

FIG. 1 represents a single or multiple layers of substances or materials that form a padded thickness. The protector's shape can be rectangle, square, round, or any shape to match the shape of garage doors

FIG. 2 represents the backside view of the garage door protector. Here magnets, screws, hooks, adhesives, or any other attaching apparatus are attached for mounting to the garage door

### LIST OF REFERENCE NUMERALS

Not applicable

### DESCRIPTION —PREFERRED EMBODIMENTS

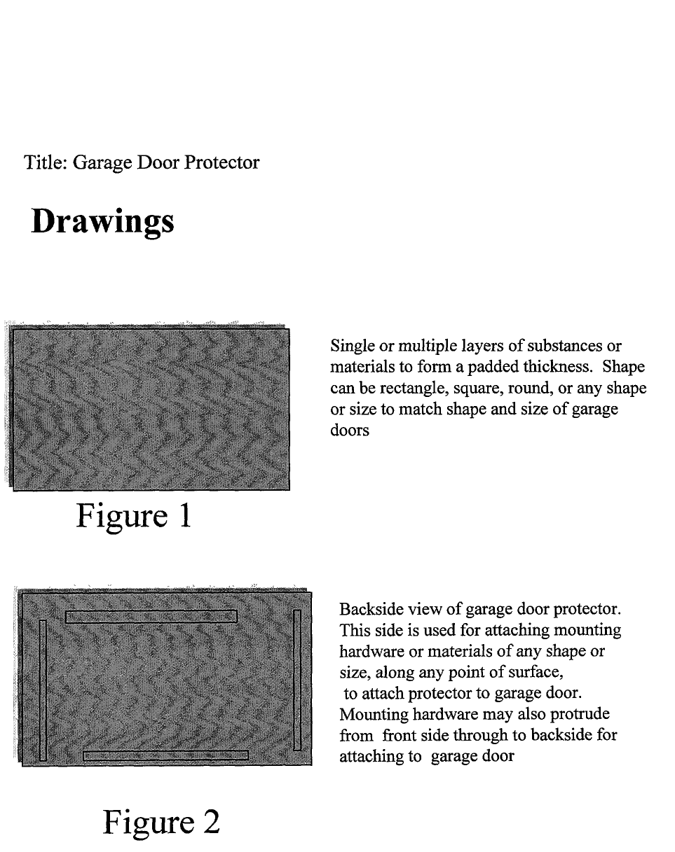

A preferred embodiment of the garage door protector is shown in FIGS. 1 and 2. The protector consisting of padded or cushioning materials or substances that are thick and light enough to provide the cushioning protection from dent or damage caused by sports balls or player to garage doors.

FIGS. 1 and 2 also represent sheets or layers of materials that can also be sectioned to fold easily via equal or un-equaled sections. The protector can then be folded for packaging or storage.

### OPERATION—MAIN EMBODIMENT

The Garage Door Protector is a device or apparatus that when attached to a garage door will protect its surface from damage. The primary use is for the protection of the garage door's outer surface from dents caused when the game of basketball is being played in a driveway or on other surfaces near a garage door. The Garage Door Protector is close in size and shape to a garage door's size. The garage door Protector is made of lightweight materials or substances so that it can be easily placed against a garage's door. The outer shell of a layered protector is waterproof or water resistant due to its outside use. A form of padded material, air, air pillows, or any impact absorbing or resistant substance, is used to fill the interior of the protector. The backside of the protector is also waterproof or resistant and also provides one of the possible surfaces for attaching the protector to a garage door. Where a single sheet, or more layers are used, the cushion affect must be maintained to protect the garage door and to resist or absorb impact. The protector provides a padded cushion affect to protect a garage's door or door's outer surface from the damage usually caused by sports players such as basketball players, when they or the ball, hits the garage door. The protector can be attached to the garage door by several different methods, such as hook and loop, magnetic strips, hooks, etc, depending on the material used to make the garage door. Most doors are made of steel, wood, or a composite. The garage door protector's total thickness can be thin enough so that the garage door may be raised. Although the garage door protector is made to be quickly removable, allowing the door to be raised with it attached, will allow vehicle access between games

### ADDITIONAL EMBODIMENTS

Not applicable

### CONCLUSIONS, RAMIFICATIONS, AND SCOPE

Accordingly, the reader will see that the garage door protector can be used to protect garage doors from damage usually caused by balls, people, or other items, hitting against a garage door. The cushioning affect that it provides will minimize or totally prevent damage to the door. Often the fear of damage to garage doors cause individuals to avoid using the length of a driveway for a more fun filled or challenging sports games Due to this fear, devices such as basketball goals are mounted at the width of a driveway, severely limiting the driveway's play surface. The garage door protector can be produced in various exterior colors with various exterior writing or graphics which can also provide a beautifying effect. The cushioning effect of the garage door protector can also help prevent injuries caused by player accidentally falling into, or being pushed into a garage door.

1. A device for preventing damage to a garage door's surface, comprising:
(a) single or multiple layers of impact resistance substances of sufficient size and shape to cover a garage door's exterior
(b) backside suitable for attaching adhesives, magnets, or other attaching device to garage's door
